(19) United States
(12) Patent Application Publication
(10) Pub. No.: US 2018/0354839 A1
(43) Pub. Date: Dec. 13, 2018

(54) CHOPPER ASSEMBLY AND METHOD FOR MANUFACTURING CHOPPED FIBERS

(71) Applicant: OCV Intellectual Capital, LLC, Toledo, OH (US)

(72) Inventor: Dominique FONT, St. Baldoph (FR)

(73) Assignee: OCV Intellectual Capital, LLC, Toledo, OH (US)

(21) Appl. No.: 15/780,674

(22) PCT Filed: Nov. 22, 2016
(86) PCT No.: PCT/US16/63238

§ 371 Date: Jun. 1, 2018

Related U.S. Application Data
(60) Provisional application No. 62/262,008, filed on Dec. 2, 2015.

(51) Int. Cl. C03B 37/16; D01G 1/04

(52) U.S. Cl. CPC C03B 37/16; D10B 2101/06; D01G 1/04

(57) ABSTRACT

An assembly for chopping glass fibers including a cutter wheel having radially extending blades and a cot wheel adjacent the cutter wheel. The cot wheel may include an inner hub and an elastomeric ring mounted onto the inner hub for rotation therewith. The elastomeric ring may include an inner portion having a first hardness and an outer portion having a second hardness that is less than the first hardness. The outer portion being positioned to contact the cutter blades during operation of the system.

### RELATED APPLICATION

This application claims priority to and all benefit of U.S. Provisional Patent Application Ser. No. 62/262,008, filed on Dec. 2, 2015, for CHOPPER ASSEMBLY AND METHOD FOR MANUFACTURING CHOPPED FIBERS, the entire disclosure of which is fully incorporated herein by reference.

### FIELD

The inventive concepts relate generally to an assembly and a method for manufacturing chopped fibers, and, more particularly, to an assembly and method for manufacturing chopped fibers that includes a hub mounted elastomeric ring that resists separation from the hub at high speeds.

### BACKGROUND

Glass fibers are used in a wide variety of applications. For example, discrete segments of glass fiber strands, or “chopped strand,” can be randomly laid across each other and held together by a binder to form a chopped strand mat that can be used as a reinforcing material in many applications. Chopped strand is typically manufactured by using a chopping assembly including a chopper wheel or roller that contains a plurality of blades that contact a drive or driven wheel or roller having a hard, elastomeric exterior surface that the blades contact. Continuous glass fibers that are drawn between the wheels are cut to form the chopped strand.

### SUMMARY

The general inventive concepts contemplate an assembly and a method for manufacturing chopped fibers.

In one exemplary embodiment, an assembly for chopping glass fibers may include a cutter wheel having plurality of radially extending blades and a cot wheel adjacent the cutter wheel. The cot wheel may include an inner hub and an elastomeric ring mounted onto the inner hub for rotation therewith. The elastomeric ring may include an inner portion having a first hardness and an outer portion having a second hardness that is less than the first hardness. The outer portion being positioned to contact the cutter blades during operation of the system.

Other aspects, advantages, and features of the general inventive concepts will become apparent to those skilled in the art from the following detailed description, when read in light of the accompanying drawings.

### BRIEF DESCRIPTION OF THE DRAWINGS

For a fuller understanding of the nature and advantages of the general inventive concepts, reference should be had to the following detailed description taken in connection with the accompanying drawings, in which:

FIG. 1 is a schematic representation of an assembly for manufacturing chopped fibers;

FIG. 2 is a perspective view of the cot wheel of the assembly of FIG. 1;

FIG. 3 is a cross-section view of the cot wheel of FIG. 1; and

FIG. 4 is an exploded view of the cot wheel of FIG. 1.

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

Unless otherwise defined, the terms used herein have the same meaning as commonly understood by one of ordinary skill in the art encompassing the general inventive concepts. The terminology used herein is for describing exemplary embodiments of the general inventive concepts only and is not intended to be limiting of the general inventive concepts. As used in the description of the general inventive concepts and the appended claims, the singular forms “a,” “an,” and “the” are intended to include the plural forms as well, unless the context clearly indicates otherwise.

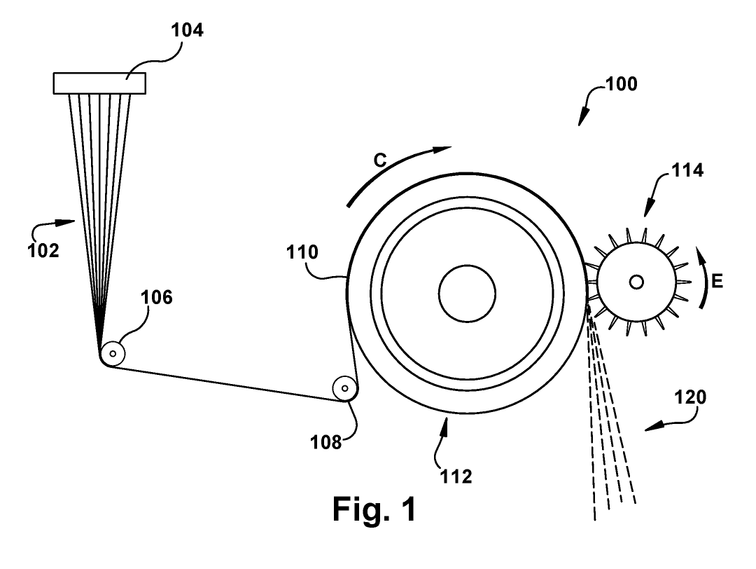

Referring now to the drawings, FIG. 1 is a partial schematic illustration of an exemplary embodiment of an assembly 100 for manufacturing discrete segments of glass fiber, or “chopped strand.” The assembly 100 may be configured in a variety of ways. For example, the assembly 100 may include various components, such as one or more glass fiber feeders, sizing application systems, various guides, pulleys, and rollers, which may be oriented in any suitable manner. For example, the components may be oriented in a manner that is know in the art, such as for example, as is set forth in U.S. Pat. No. 4,194,896, U.S. Pat. No. 4,411,180, and U.S. Pat. No. 6,415,997, each of which are incorporated herein by reference in their entirety.

In the illustrated embodiment, a plurality of continuous glass fibers 102 are drawn from one or more feeders 104 around a guide roll 106 and an idler roll 108. FIG. 1 illustrates a single feeder 104, but any number of feeders may be incorporated in the assembly 100. The guide roll 106 and the idler roll 108 are configured and positioned to arrange the fibers 102 in a generally planar orientation and bring the fibers 102 into engagement with a circumferential surface 110 of a first rotatable member or cot wheel 112.

As illustrated in FIG. 1, the cot wheel 112 is driven in a clockwise direction, as shown by arrow C, which pulls the fibers around the circumferential surface 110 of the cot wheel 112 to a position in which a second rotatable member or cutter wheel 114 is in contact with the cot wheel 112. As illustrated, the cutter wheel 114 rotates in a counterclockwise direction as shown by the arrow E. The cutter wheel 114 includes a plurality of radially extending blades 116 which contact the circumferential surface 110 of the cot wheel 112 to cut the fibers 102 into discrete segments 120.

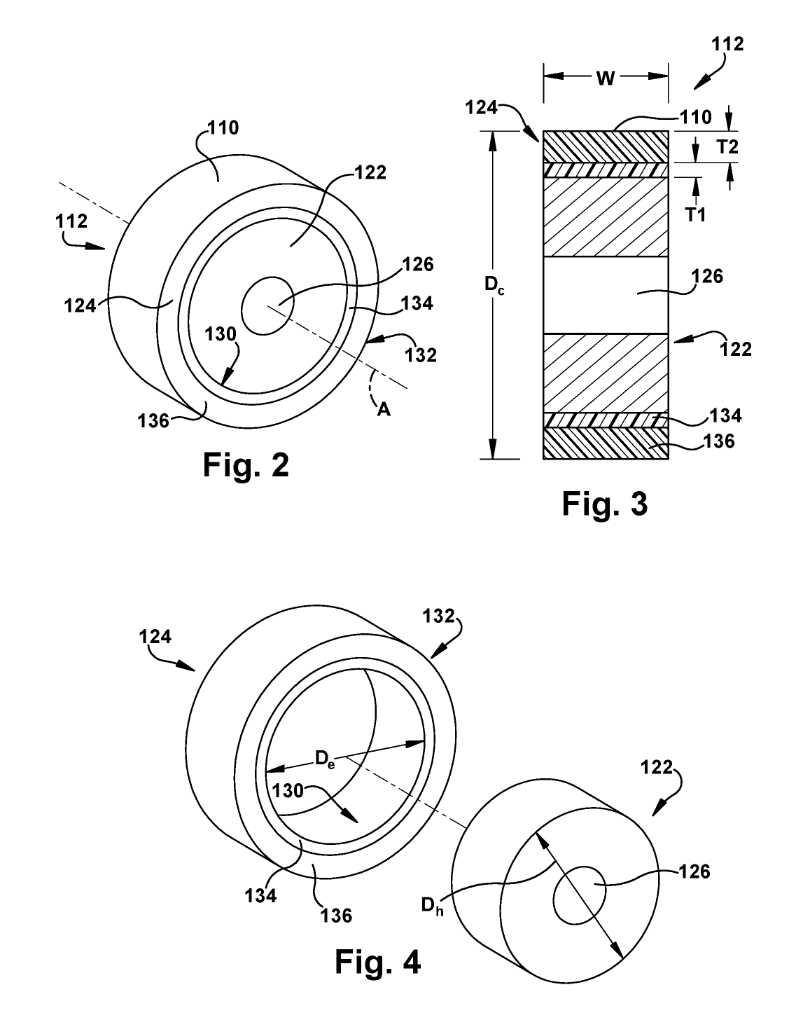

Referring to FIGS. 2-4, the cot wheel 112 may be configured in a variety of ways. In the exemplary embodiment, the cot wheel 112 has a width W, a diameter Dc, and includes an inner hub 122 and an outer elastomeric ring 124. The inner hub 122 may be configured in a variety of ways. In the illustrated embodiment, the inner hub 122 is formed from any suitable material. In one exemplary embodiment, the hub is formed from a lightweight metal, such as for example, aluminum. The inner hub 122 has a diameter Dh and a mounting bore 126 to facilitate mounting the inner hub 122 on a drive shaft (not shown) for rotation about a central longitudinal axis A. In some embodiments, the hub diameter Dh is in the range of about 400 mm to about 700 mm. In other embodiments, however, the hub diameter Dh may be less than 400 mm or greater than 700 mm.

The elastomeric ring 124 has an inner diameter De and may include an inner portion 130 having a first hardness and an outer portion 132 having a second hardness that is less than the first hardness. The elastomeric ring 124 may be configured in a variety of ways. For example, the elastomeric material(s) used, the number of different elastomeric materials used, the thickness of the ring, the thickness of the inner portion and the outer portion, and the hardness of the inner portion and the outer portion may vary in different embodiments. In the illustrated embodiment, the inner portion 130 of the elastomeric ring 124 includes an inner ring 134 made from a first elastomer and the outer portion 132 includes an outer ring 136 that is fixed to the inner ring and made from a second elastomer that has a hardness that is less than the hardness of the first elastomer.

The difference in hardness between the inner portion 130 and the outer portion 132, however, may be achieved in any suitable manner. For example, the elastomeric ring 124 may be made from a single elastomeric material that is treated (e.g., chemically or physically) in the inner portion 130 or outer portion 132 to create the hardness difference between the inner and outer portions.

In the exemplary embodiment, the inner ring 134 may be fixed to the outer ring 136 in any suitable manner. For example, the inner ring 134 may be fixed to the outer ring 136 by molding, by adhesives, by physical fasteners, by press or friction fit, or any other suitable manner of attachment. The inner ring 134 and the outer ring 136 may be made of any suitable elastomeric material or materials. Suitable elastomeric materials include, but are not limited to rubber and polyurethane. A polyurethane, if used, may be made from any suitable diisocyanates (e.g., methylene diphenyl diisocyanate (MDI), toluene diisocyanate (TDI), 1,5-naphthalene diisocyanate (NDI)) and polyols (e.g., polyester, polyether). In one exemplary embodiment, the inner ring 134 and the outer ring 136 are made of the same kind of material (i.e. the same chemical nature) which improves the adherence between the inner ring 134 to the outer ring 136 due to the chemical compatibility as well as avoiding any shearing at the interface between the inner and outer rings 134, 136.

The hardness of the inner portion 130 and the outer portion 132 may vary in different embodiments. In one exemplary embodiment, the inner portion 130 has a hardness in the range of about 60 Shore D to about 80 Shore D, or in the range of about 70 Shore D to about 80 Shore D. In one exemplary embodiment, the outer portion 132 has a hardness in the range of about 80 Shore A to about 99 Shore A, or about 90 Shore A to about 99 Shore A. In one exemplary embodiment, the inner portion 130 has a hardness of about 75 Shore D and the outer portion 132 has a hardness of about 95 Shore A.

The inner portion 130 has a first thickness T1 and the outer portion 132 has a second thickness T2. The first thickness T1 and the second thickness T2 may vary in different embodiments. In one exemplary embodiment, the first thickness T1 is less than the second thickness T2. In other embodiments, however, the first thickness T1 may be equal to or greater than the second thickness T2. In some exemplary embodiments, the first thickness T1 is in the range of about 4 mm to about 12 mm, or in the range of about 6 mm to about 10 mm. In some exemplary embodiments, the second thickness T2 is in the range of about 30 mm to about 60 mm, or in the range of about 40 mm to about 50 mm. In some exemplary embodiments, the ratio of first thickness to second thickness is in the range of about 1:2 to about 1:15, or about 1:5 to about 1:7.

The elastomeric ring 124 may be mounted onto the inner hub 122 by any suitable manner. For example, in some embodiments, the elastomeric ring 124 is molded onto the inner hub 122 or fixed to the inner hub by an adhesive. In the exemplary embodiment, the elastomeric ring 124 is pressed onto the inner hub 122 (as shown by dashed lines in FIG. 4). The inner diameter De of the elastomeric ring 124 is slightly smaller than the outer diameter Dh of the inner hub 122. Thus, when pressed onto the inner hub 122, an interference fit is formed to attach the elastomeric ring 124 to the inner hub 122. The interference fit is sufficient to hold the elastomeric ring 124 fixed to the inner hub 122 but also allow the elastomeric ring to be removed without the need to overcome a chemical bond.

In operation, as the cot wheel 112 rotates, it pulls the fibers 102 around the perimeter of the cot wheel 112 and in between the cot wheel and the cutter wheel 114. The blades 116 on the cutter wheel 114 contact the circumferential surface 110 of the cot wheel 112 such that the fibers 102 therebetween are severed. The hardness, and other properties, of the elastomeric material of the outer portion 132 (or on circumferential surface 110) are configured to facilitate the attenuation, the wear resistance, and effective cutting of the continuous fibers 102, as well as provide suitable grip of the fibers 102 on the circumferential surface 110 of the cot wheel 112 and to overcome strain of the cot wheel bushing (not shown). The hardness, however, of the outer portion 132 may not be well suited to maintain a clamping force between the elastomeric ring 124 and the inner hub 122 at high rotational speeds.

Typical rotational speed of the cot wheel 112 may vary with different configurations of the cutting assembly 100. In some embodiments, for example, the rotational speed of the cot wheel 112 is such that the linear speed of the fibers 102 is about 20 m/sec or greater. As rotational speed increases, centrifugal forces act against the clamping forces that hold the elastomeric ring 124 onto the inner hub 122. If the centrifugal forces were to overcome the clamping forces, the elastomeric ring 124 would slip relative to the inner hub 122 and potentially cause operational problem with the process.

The hardness of the inner portion 130 of the elastomeric ring 124 is selected to provide increased resistance to the centrifugal forces overcoming the clamping forces when the rotational speed of the cot wheel 112 (and line speed of the process) is increased, as well as provide improved clamping forces of the elastomeric ring 124 onto the inner hub 122. Thus, by providing an elastomeric ring 124 with an inner portion 130 that is harder than the outer portion 132 (or circumferential outer surface 110) of the elastomeric ring 124, the cutting assembly 100 may operate at higher line speeds without resulting in movement between the elastomeric ring 124 and the inner hub 122.

The above description of specific embodiments has been given by way of example. From the disclosure given, those skilled in the art will not only understand the general inventive concepts and their attendant advantages, but will also find apparent various changes and modifications to the structures and concepts disclosed. It is sought, therefore, to cover all such changes and modifications as fall within the spirit and scope of the general inventive concepts, as defined herein and by the appended claims, and equivalents thereof.

We claim:

1. An assembly for chopping glass fibers, comprising:
a cutter wheel having a plurality of radially extending blades; and
a cot wheel adjacent the cutter wheel, the cot wheel comprising
an inner hub; and
an elastomeric ring mounted onto the inner hub for rotation therewith, the elastomeric ring having an inner portion having a first hardness and an outer portion having a second hardness that is less than the first hardness, the outer portion being positioned to contact the cutter blades during operation of the assembly.

2. The assembly of claim 1, wherein the elastomeric ring is pressed onto the inner hub.

3. The assembly of claim 1, wherein the elastomeric ring comprises polyurethane.

4. The assembly of claim 3, wherein the inner portion is an inner ring of a first polyurethane and the outer portion is an outer ring of a second polyurethane fixed to the inner ring.

5. The assembly of claim 4, wherein the inner ring has a thickness in the range of about 4 mm to about 12 mm.

6. The assembly of claim 4, wherein the outer ring has a thickness in the range of about 30 mm to about 60 mm.

7. The assembly of claim 1, wherein the first hardness is in the range of about 60 Shore D to about 80 Shore D.

8. The assembly of claim 1 wherein the second hardness is in the range of about 80 Shore A to about 99 Shore A.

9. A rotatable member for use in a glass fiber chopping assembly, comprising:
a cylindrical inner hub; and
an elastomeric ring mounted onto the inner hub for rotation therewith, the elastomeric ring having an inner portion having a first hardness and an outer portion having a second hardness that is less than the first hardness.

10. The rotatable member of claim 9, wherein elastomeric ring is pressed onto the inner hub.

11. The rotatable member of claim 9, wherein the elastomeric ring comprises polyurethane.

12. The rotatable member of claim 11, wherein the inner portion is an inner ring of a first polyurethane and the outer portion is an outer ring of a second polyurethane fixed to the inner ring.

13. The rotatable member of claim 12, wherein the inner ring has a thickness in the range of about 4 mm to about 12 mm.

14. The rotatable member of claim 12, wherein the outer ring has a thickness in the range of about 30 mm to about 60 mm.

15. The rotatable member of claim 9, wherein the first hardness is in the range of about 60 Shore D to about 80 Shore D.

16. The rotatable member of claim 9, wherein the second hardness is in the range of about 80 Shore A to about 99 Shore A.

17. A method of cutting glass fibers, comprising:
drawing continuous glass fibers from a glass fiber feeder;
bringing the glass fibers into engagement with a circumferential surface of a first rotatable member;
rotating the first rotatable member to bring the glass fibers into contact with one or more cutter blades;
cutting the glass fibers into discrete segments with the one or more blades;
wherein the first rotatable member includes an elastomeric ring mounted onto an cylindrical inner hub for rotation therewith, the elastomeric ring having an inner portion having a first hardness and the circumferential surface having a second hardness that is less than the first hardness.

18. A method of claim 17, wherein the inner portion comprises a polyurethane, wherein the first hardness is in the range of about 60 Shore D to about 80 Shore D, wherein the circumferential surface comprises a polyurethane, and wherein the second hardness is in the range of the second hardness is in the range of about 80 Shore A to about 99 Shore A.
